(19) United States
(12) Patent Application Publication
(10) Pub. No.: US 2002/0167690 A1
(43) Pub. Date: Nov. 14, 2002

(54) Image sending method and image sending device

(76) Inventors: Shuhuji Fujii, Soraku-gun (JP); Takashi Imai, Nara-shi (JP)

Correspondence Address: Dike, Bronstein Roberts & Cushman LLP, 130 Water Street, Boston, MA, 02109, US

(21) Appl. No.: 10/068,414

(22) Filed: Feb. 6, 2002

(30) Foreign Application Priority Data
May 9, 2001 (JP) 2001-138457

(51) Int. Cl. H04N 1/00; H04N 1/46

(52) U.S. Cl. 358/539; 358/407

(57) ABSTRACT

An image sending device has a functional block in the control section for the resolution setting operation. The control section is made up of a sending destination/sending mode setting section for setting a sending mode for sending image data from plural types of sending modes, an image quality setting section for setting an image quality for the sending image data, a resolution setting section for setting a resolution corresponding to the image quality set by the image quality setting section, referring to a resolution setting table, from a range of applicable resolutions for the sending mode set by the sending destination/sending mode setting section, and an image processing section for processing the image data, based on the resolution set by the resolution setting section into a form suitable for the sending mode set by the sending destination/sending mode setting section. This makes it possible to set a suitable resolution according to the sending mode by specifying the image quality, thereby easily setting the resolution.

### FIELD OF THE INVENTION

The present invention relates to an image sending method and an image sending device, and in particular to an image sending method and an image sending device which is provided with plural types of encoding mode, and sends image data after encoding it through a specific encoding mode.

### BACKGROUND OF THE INVENTION

A conventional of an image sending device having plural sending modes is the color facsimile device, a color facsimile device which is disclosed in Japanese Unexamined Patent Publication No. 113146/1994 (Tokukaihei 6-113146 published on Apr, 22, 1994) can be named as an image sending device having plural sending modes.

The facsimile device adopts a MMR (modified modified READ) mode for sending monochrome images, and a JPEG (Joint Photographic Experts Group) mode for sending color images as the encoding mode. This facsimile device is capable of freely setting resolutions for each of these two encoding modes.

When sending image data through the facsimile device, a user chooses either standard resolution (200 dpi×200 dpi) or fine resolution (400 dpi×400 dpi) after choosing either the MMR mode or the JPEG mode. Then, the facsimile device sends the image data through a communication line by encoding it according to the encoding mode and the resolution selected by the user.

Further, in recent years, multi-function devices having the functions of a printer, a facsimile, a scanner or the like are adopted to send images scanned by a scanner not only through a communication line (hereinafter referred to as “fax mode”), but also as E-mail to a network (hereinafter referred to as “Scan to E-mail mode”) or as a file to a network based on FTP (file transfer protocol) (hereinafter referred to as “Scan to FTP mode”).

However, in such a multi-function device, the sending modes have different upper limits of resolution and different upper limits of capacity of sendable image data. Therefore, it is not possible to match resolutions of all sending modes even when the same image quality is selected. For example, when specifying “fine” as the image quality, the required resolution value varies in the fax mode, Scan to E-mail mode and Scan to FTP mode.

Accordingly, in the conventional multi-function device having plural sending modes such as the fax mode, the Scan to E-mail mode and the Scan to FTP mode and the like, it was necessary to set resolution according to the sending mode which was selected by a user. However, for a user who is not knowledgeable about resolution, it was difficult to select an appropriate value of resolution from a set of different resolutions for each sending mode.

### SUMMARY OF THE INVENTION

The present invention is made to solve the foregoing problems, and an object of the present invention is to provide an image sending method and an image sending device which are capable of easily setting a resolution for plural sending modes which respectively are capable of adopting various resolutions.

In order to attain the foregoing object, an image sending method according to the present invention selects and sets the sending mode for sending image data from plural types of sending modes, and sets the image quality for the sending image data, and sets the resolution corresponding to the selected image quality selected from a range of applicable resolutions for the selected sending mode, and also, sends the image data of the selected resolution by the selected sending mode.

The image data may be sent after it is processed based on the selected resolution into a form suitable for the selected sending mode. Further, the image data may also be sent after it is created by reading an image which was read out based on the selected resolution.

With the foregoing method, it is possible to select and set a resolution suitable for the sending mode by specifying the level (for example, coarse, standard, fine) of the image quality of the sending image data. Therefore it becomes possible to simplify the resolution setting when selecting one of plural sending modes respectively requiring different resolutions, and when sending an image through the selected sending mode. As a result, it becomes easier for a user who is not knowledgeable about resolution to select and set a suitable resolution for each sending mode from plural resolutions.

Further, an image sending device according to the present invention includes: a sending mode setting means for selecting and setting a sending mode to send image data from plural types of sending mode, image quality setting means for setting the image quality of sending image data, and resolution setting means for selecting and setting the resolution corresponding to the image quality set by the image quality setting means from the range of applicable resolutions for the sending mode set by the sending mode setting means.

With the foregoing arrangement, specifying the level of image quality of the sending image data allows the resolution setting means to set a resolution suitable for the sending mode, thereby simplifying the resolution setting of plural sending modes requiring different resolutions. Consequently, it becomes easier for a user who is not knowledgeable about resolution to select and set a suitable resolution value for each sending mode from plural resolutions.

Note that, the resolution setting means may refer to a resolution setting table which stores a range of applicable resolutions of each sending mode with the corresponding index of the image quality common to the plural types of sending modes.

In this case, using the resolution setting table based on the sending mode and image quality makes it easier to select the optimum resolution. Besides, since the index of image quality is common to plural types of sending modes, it is easy to grasp a state of sending image data. Consequently, it becomes even more easier for a user who is not knowledgeable about resolution to select and set the applicable resolution.

Further, an image sending device according to the present invention includes: a sending route setting section for selecting and setting a sending route from plural image sending routes, an image quality setting section for setting an image quality of a sending image, and a processing contents setting section for setting the processing contents which corresponds to the image sending route set by the sending route setting section and the image quality set by the image quality setting section, and an image processing section for processing the image to create the sending image based on the processing contents set by the processing contents setting section, and an image sending section for sending the sending image via the selected image sending route.

Here, examples of image processing contents includes, enlargement/reduction of an image to match the size of a sending image, conversion of a color image into a monochrome image, subtractive operation of colors and the like.

In the foregoing structure, the image quality setting section sets the image quality of the sending image by specifying the level of the image quality of the sending image. This enables the processing contents setting section to select and set the processing contents suitable for the image sending route which was set by the sending route setting section.

Therefore, it becomes possible to set the processing contents more easily when selecting one of plural sending routes which respectively require different image processing contents and when sending an image through the selected sending route. As a result, it becomes easier for a user who is not knowledgeable about processing contents to select and set suitable processing contents from plural processing contents.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a functional block diagram explaining resolution setting operations of an image sending device shown in FIG. 2.

FIG. 2 is a block diagram schematically showing an arrangement of the image sending device according to one embodiment of the present invention.

FIG. 3 is a flow chart schematically showing the image sending operations of the image sending device shown in FIG. 2.

FIG. 4 is a flow chart schematically showing the resolution setting operations of the image sending device shown in FIG. 2.

FIG. 5 is an explanatory drawing explaining a resolution setting table which is used in the resolution setting operations of the image sending device shown in FIG. 2.

FIGS. 6 through 16 are explanatory drawings showing a screen displayed in a control panel of the image sending device shown in FIG. 2.

### DESCRIPTION OF THE EMBODIMENTS

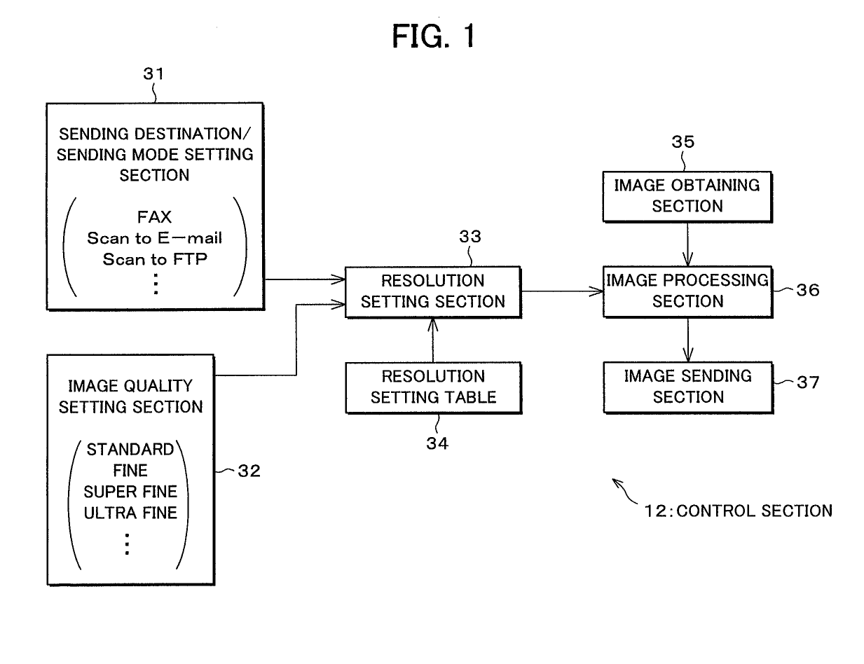

The following will explain one embodiment of the present invention with reference to FIGS. 1 through 16.

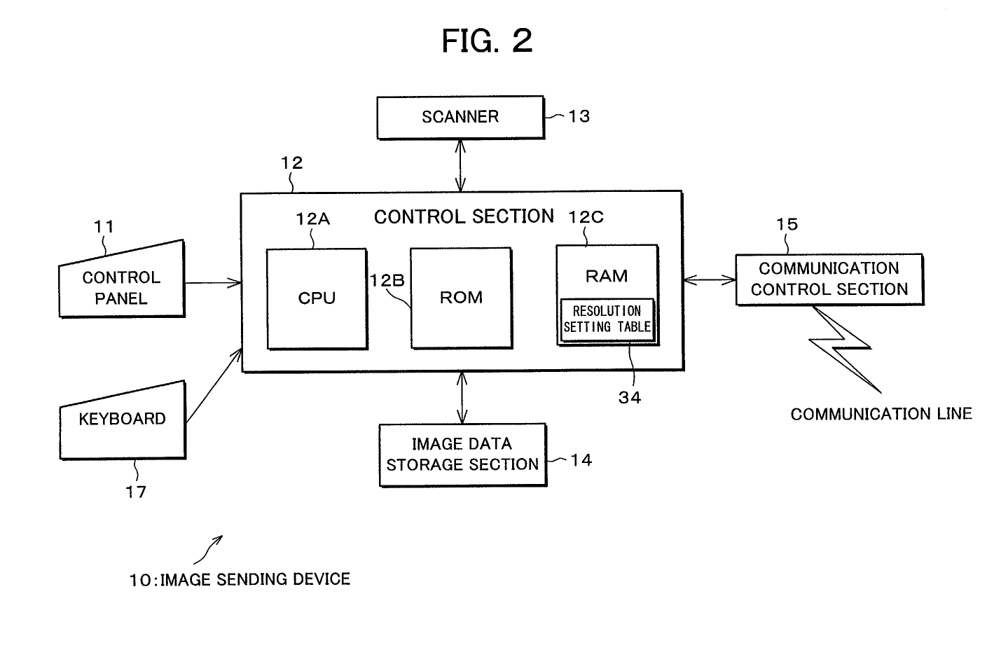

FIG. 2 is a block diagram schematically showing a arrangement of an image sending device 10 according to the present invention. Note that, the image sending device 10 is applicable to a multi-function image processing device having the functions of a facsimile, a photocopier, a scanner, a printer and the like.

The image sending device 10 is made up of at least: a control panel 11, a control section 12, a scanner 13, an image data storage section 14, and a communication control section 15.

Note that, in the present embodiment, the control panel 11 will be described as a touch panel which changes its operation display depending on the operation step. However, a display device (display means) and an input device (input means) of the image sending device 10 may be of any kind. Further, in addition to the control panel 11, the image sending device 10 may have a keyboard 17 which can be used to enter numbers, alphabets, codes, etc.

Further, in the present embodiment, the scanner 13 will be described as an optical scanner which generates image data by scanning a document; however, an image reading device (image reading means) of the image sending device 10 may be of any kind. For example, a video camera which generates moving image data by shooting an object can be used as the image reading device.

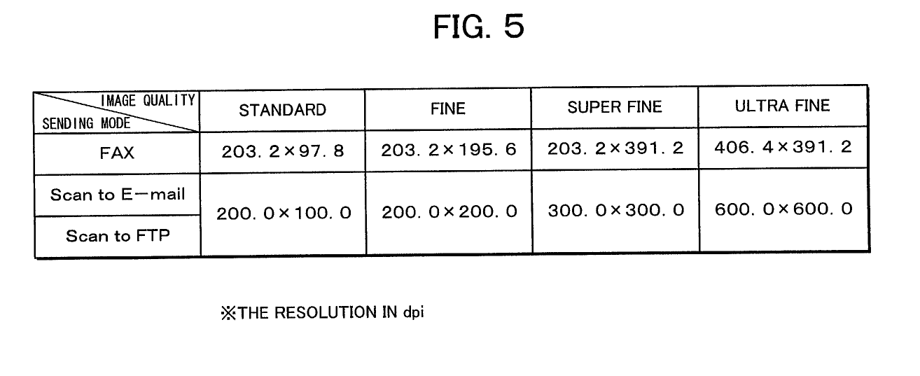

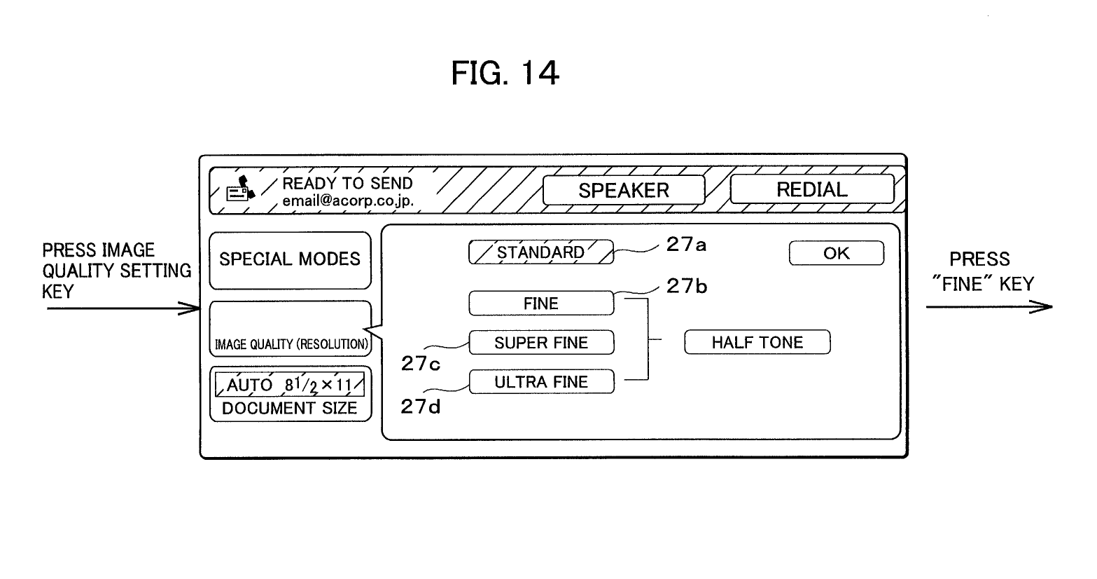

The following will briefly explain operations of the image sending device 10. First, in response to a request for entry of a sending destination, a sending destination and a sending mode are set based on input from the control panel by a user. Second, a document is scanned by the scanner 13, and the image data of the document temporarily stored in the image data storage section 14. Third, after storing the image data into the image data storage section 14, a resolution for converting the image data is set, referring to a resolution setting table 34 (FIG. 1, FIG. 5) stored in a RAM (Randam Access Memory) 12C, based on the image quality data which was inputted from the control panel 11 (To be more specific, the image quality keys 27a through 27d (FIG. 14)) by the user in response to a request for entry of image quality. Forth, the image data stored in the image data storage section 14 is converted in accordance with the resolution. Finally, the communication control section 15 sends the converted image data to an external facsimile device, a computer terminal, etc., in accordance with the selected sending mode via a telephone line or a network.

FIG. 1 is a functional block diagram for explaining the resolution setting operation of the image sending device 10.

The image sending device 10 has the following function block in the control section 12 for the resolution setting operation. Namely, the control section 12 is made up of a sending destination/sending mode setting section (sending mode setting means) 31, an image quality setting section (image quality setting means) 32, a resolution setting section (resolution setting means) 33, a resolution setting table 34, an image obtaining section 35, an image processing section (image data processing means) 36, and an image sending section 37.

The sending destination/sending mode setting section 31 obtains sending destination information from a user via the control panel 11, etc. Here, the sending destination/sending mode setting section 31 sets a fax mode if the obtained sending destination information is a fax number, a Scan to E-mail mode if it is a E-mail address, and a Scan to FTP mode if it is based on FTP.

The image quality setting section 32 obtains information for specifying image quality of the sending image data by the user via the control panel 11. Here, in the image sending device 10, the information is one of “standard”, “fine”, “super fine” and “ultra fine”.

The resolution setting section 33 sets a resolution for the sending image data based on the sending mode obtained by the sending destination/sending mode setting section 31 and the image quality obtained by the image quality setting section 32. Here, the resolution setting section 33 refers to the resolution setting table 34 (FIG. 5) which is stored in the RAM 12C.

The image obtaining section 35 obtains image data from the scanner 13. Note that, the image obtaining section 35 may obtain image data from a personal computer or the like, in addition to or instead of the optical scanner.

The image processing section 36 converts the image data which was obtained by the image obtaining section 35, based on the sending mode specified by the sending destination/sending mode setting section 31 at the resolution determined by the resolution setting section 33.

The image sending section 37 sends the image data converted by the image processing section 36 via the communication control section 15 in the sending mode to which was specified by the sending destination obtained by the sending destination/sending mode setting section 31.

Note that, the control operation (including the functional block shown in FIG. 1) of the image sending device 10 is performed by the control section 12 in accordance with a predetermined program. In order to carry out this control operation, the control section 12 of the image sending device 10 at least has a CPU (central processing unit) 12A which executes a program (image sending program) for realizing the functions, a ROM (read only memory) 12B which stores the boot logic or the like, and a RAM 12C which stores the program and various data (including sending destination information, sending mode data, image quality data, resolution data).

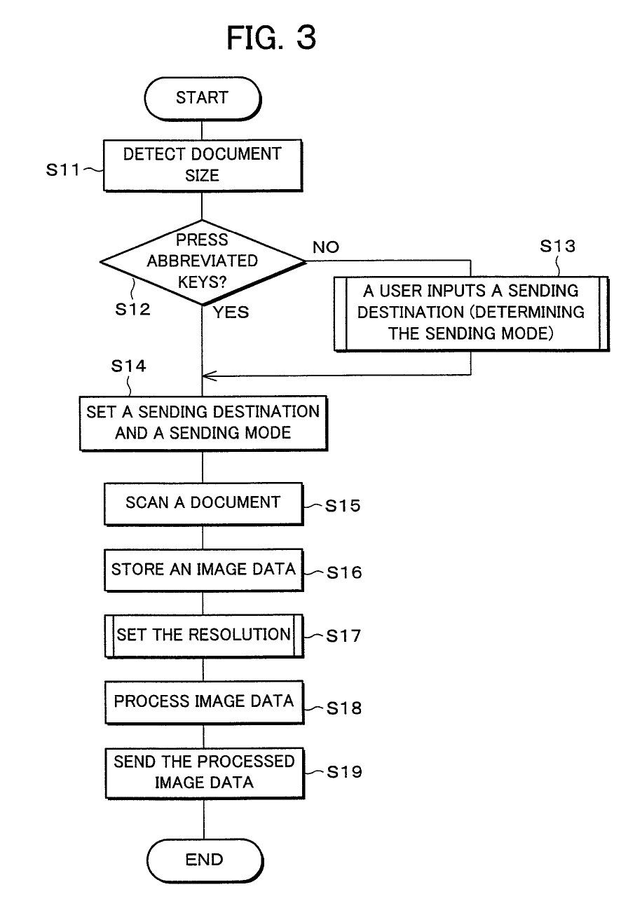

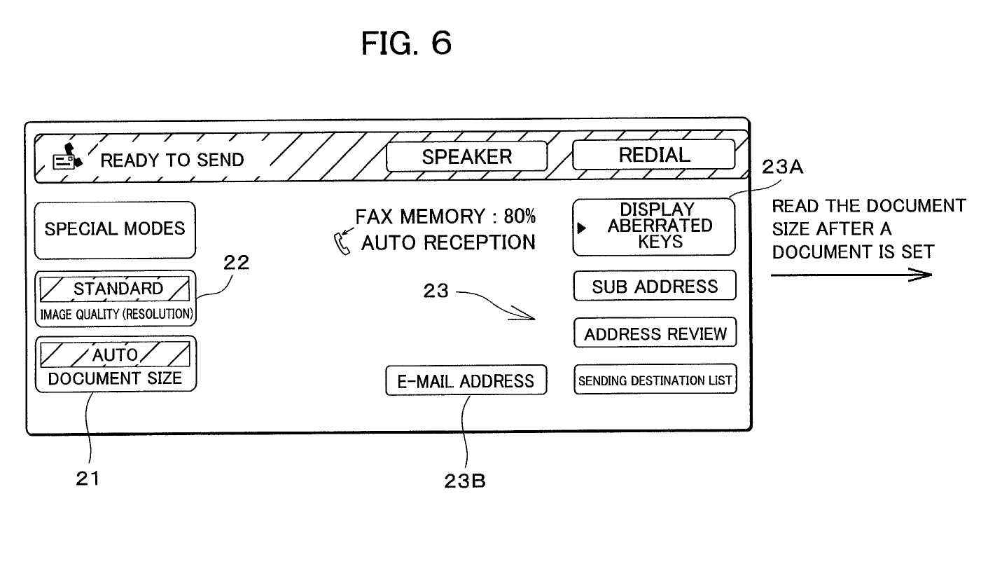

The following will explain the operation of the image sending device 10 in more detail with reference to FIG. 3, FIGS. 6 through 11, FIG. 15.

Firstly, as shown in FIG. 6, the control panel 11 in its initial state displays various keys, such as a document size setting key 21, an image quality setting key 22, and a sending destination setting key 23 and the like. The sending destination setting key 23 includes plural keys such as an abbreviated key displaying key 23A, an E-mail address setting key 23B and the like.

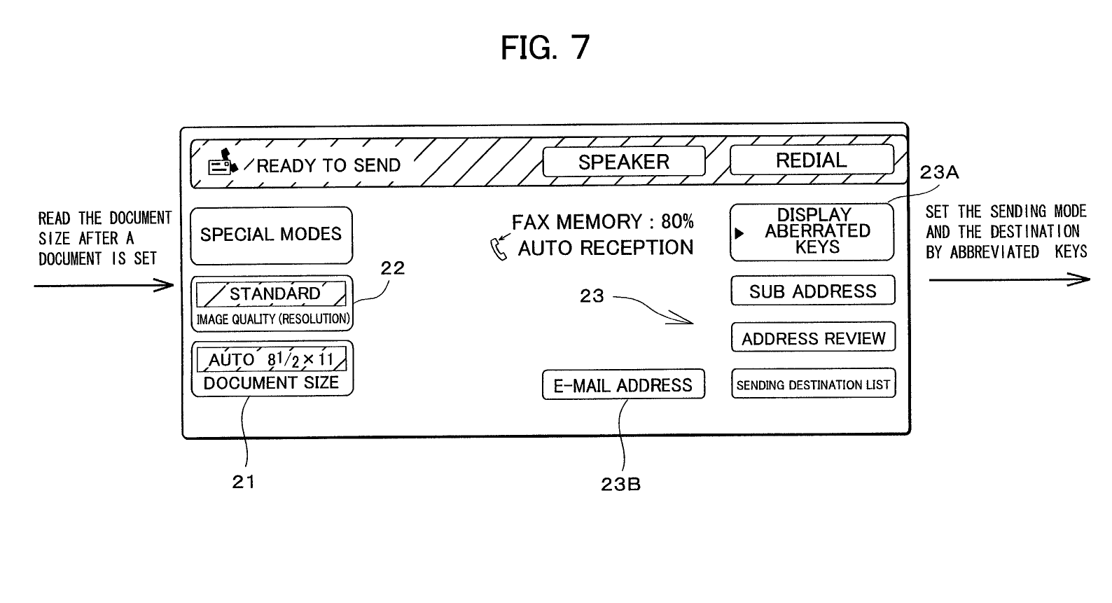

Then, when a document is set on a document set tray (not shown) by the user, the scanner 13 detects the document size (S11), and, the detected size is displayed in the document setting key 21 of the control panel 11 (FIG. 7).

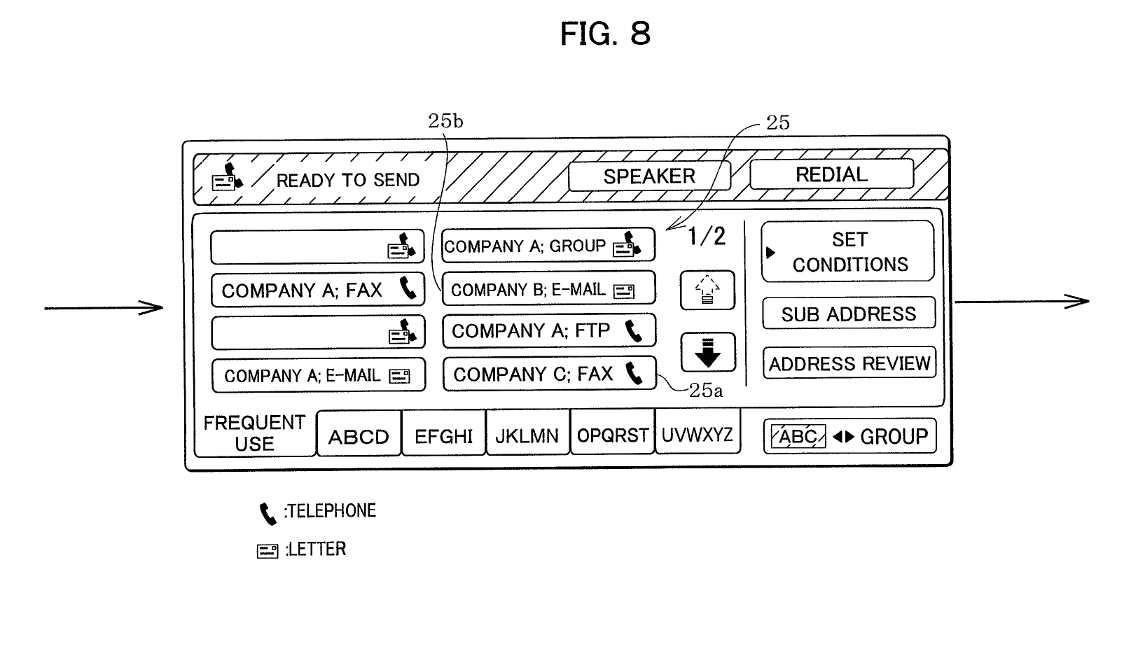

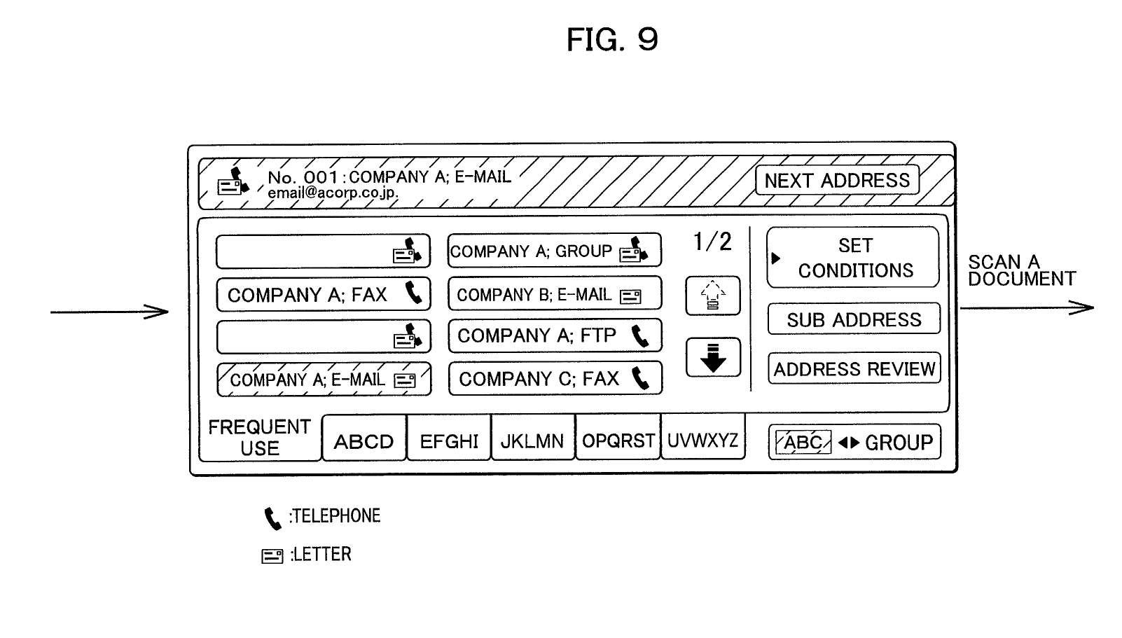

Next, the sending destination/sending mode setting section 31 requests the user to set the sending destination, and then sets the sending destination and sending mode based on the input of the user using the sending destination setting key 23 or the like (S12 through S14, FIG. 8, FIG. 9).

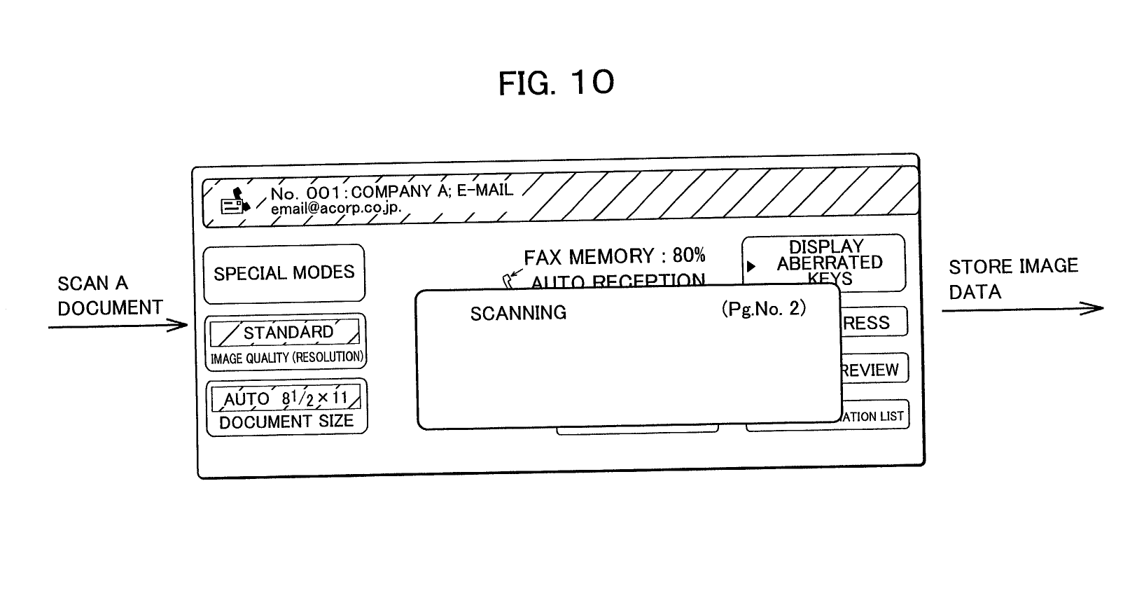

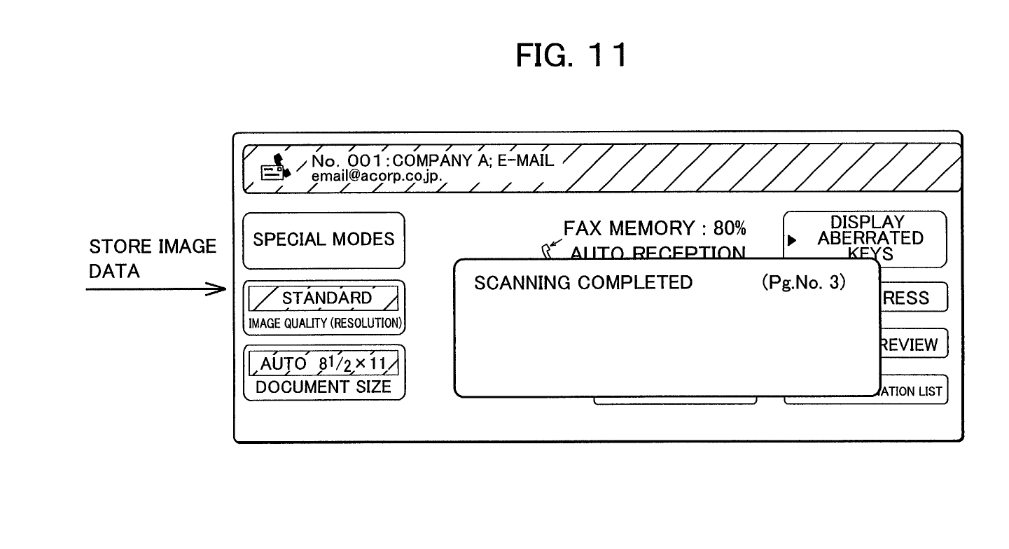

Next, the scanner 13 scans the document under the control of the image obtaining section 35 (S15, FIG. 10), and then, the scanned image data is temporarily stored in the image data storage section 14 (S16, FIG. 11).

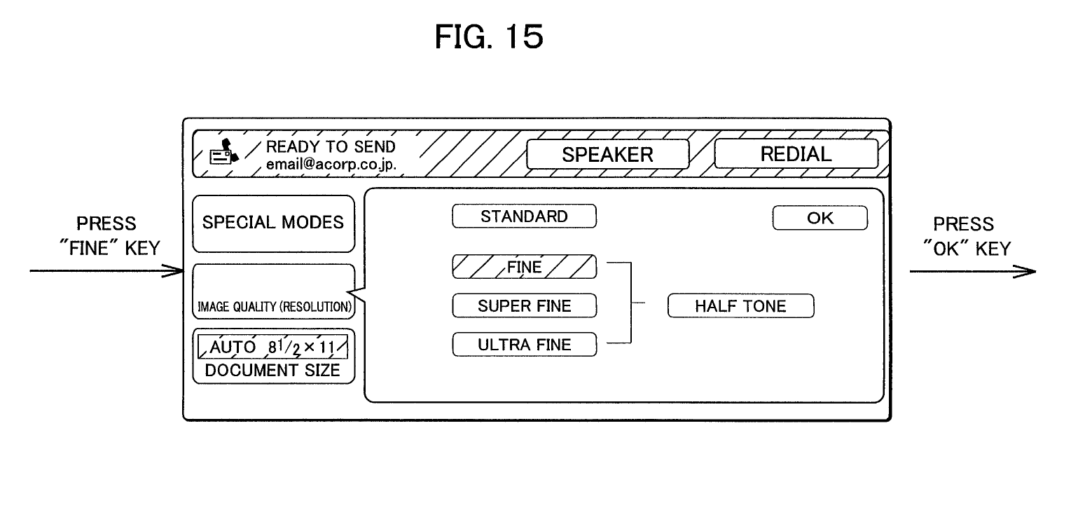

Next, the image quality setting section 32 requests a user to set the image quality, and then obtains the image quality of the sending image based on the input of the user using the image quality setting key 22 or the like. Then, the resolution setting section 33 determines the resolution of the sending image according to the sending mode and the image quality in accordance with the resolution setting table 34 (S17, FIG. 15).

Next, after setting the resolution, the image processing section 36 reads out the image data stored in the image data storage section 14, then processes the image data in accordance with the sending mode specified by the user and the resolution corresponding to the image quality specified by the user (S18).

Finally, when the user presses the “send” key (start key) (not shown), the communication control section 15 under the control of the image sending section 37 sends the image data of the resolution corresponding to the specified image quality to the specified destination via a telephone line or a network such as the Internet or the like, based on the specified sending mode (S19).

The following will explain how the sending mode is set with reference to FIG. 3, FIGS. 5 through 9, FIG. 12.

1. Fax Mode

The fax mode can be set in two different ways in the image sending device 10:

(1) A method using abbreviated keys 25 (FIG. 8) which pre-stores the fax number of the sending destination and the information which specifies the fax mode; and

(2) A method which directly inputs the fax number of the sending destination using the number keys.

(1) The Method Using Abbreviated Keys.

After detecting the document size (S11, FIG. 7), when the abbreviated key display key 23A of the control panel 11 is pressed, the abbreviated keys 25 stored in the RAM 12C are displayed in the form of a list (FIG. 8). Here, in FIG. 8, among the abbreviated key 25, the fax mode is set for sending destination keys 25a marked with a telephone. Thus, when the sending destination key 25a marked with a telephone is selected, the sending destination/sending mode setting section 31 sets the sending mode to the fax mode while setting a fax number for the sending destination (YES in S12, S14).

Note that, the sending destination is not necessarily one, but can be a group of plural sending destinations. The telephone and letter marks in the abbreviated keys 25 in FIG. 8 indicate that some of the sending destinations in a group of sending destinations adopts fax mode, and the rest adopts the Scan to E-mail mode or Scan to FTP mode.

(2) The Method Using the Number Keys.

After detecting the document size (S11, FIG. 7), when entry from the number keys of the keyboard 17 is detected while the control panel 11 is displays the screen shown in FIG. 7, the sending destination/sending mode setting section 31 obtains the key entry as a fax number for the sending destination and automatically sets the sending mode to the fax mode (NO S12, S13, S14). Note that, the number keys may be displayed in the control panel 11.

2. Scan to E-Mail Mode

The scan to E-mail mode can be set in two different ways in the image sending device 1:

(1) A method using the abbreviated keys 25 (FIG. 8) which pre-stores the E-mail address of the sending destination and the information which specifies the scan to E-mail mode; and

(2) A method which directly inputs the E-mail address of the sending destination using a keyboard.

(1) The Method Using Abbreviated Keys.

After detecting the document size (S11, FIG. 7), when the abbreviated key display key 23A of the control panel 11 is pressed, the abbreviated keys 25 stored in the RAM 12C are displayed in the form of a list (FIG. 8). Here, in FIG. 8, among the displayed abbreviated keys 25, the Scan to E-mail mode is set for sending destination key 25b marked with a letter. Thus, when the sending destination key 25b marked with a letter is selected, the sending destination/sending mode setting section 31 sets the sending mode to the Scan to E-mail mode while setting an E-mail address for the sending destination (YES in S12, S14, FIG. 9). Note that, the sending destination is not necessarily one, but can be a group of plural sending destinations.

(2) The Method Using the Keyboard.

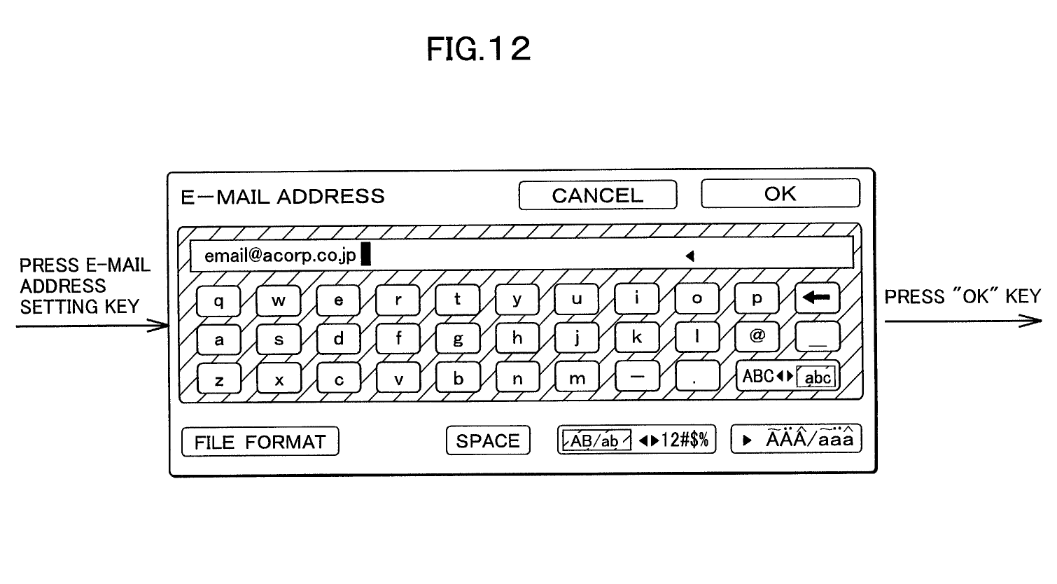

After detecting the document size (S11, FIG. 7), when the E-mail address setting key 23B is pressed in the control panel 11 of FIG. 7, a keyboard for entering an E-mail address is displayed in the control panel 11 (No in S12, S13, FIG. 12). This allows a user to enter the E-mail address of the sending destination by pressing the keys displayed in the control panel 11. When the user finishes entry and presses the “OK” key, the control section 12 returns the control panel 11 to its previous state after setting the Scan to E-mail mode. Thereafter, image scanning is started in response to the operation of the user (S15, FIG. 10).

In this manner, the sending destination/sending mode setting section 31 sets the sending mode to the Scan to E-mail mode while obtaining the entry of the user as the E-mail address of the sending destination (S14). Note that, in the case where entry from the keyboard 17 is detected while the control panel 11 is displaying the screen shown in FIG. 12, the control section 12 may obtain the entry as an E-mail address.

3. Scan to FTP Mode

The scan to FTP mode can be set in two different ways in the image sending device 10:

(1) A method using abbreviated keys 25 (FIG. 8) which pre-stores the sending destination information of FTP (a port, an address, the name of a user, a password (the name of a user and a password are not required in some cases) and the information which specifies the FTP mode; and

(2) A method which directly inputs the sending destination information using the keyboard.

Note that, explanations of the two setting methods above are omitted since these methods are the same as those of the Scan to E-mail mode which were already described.

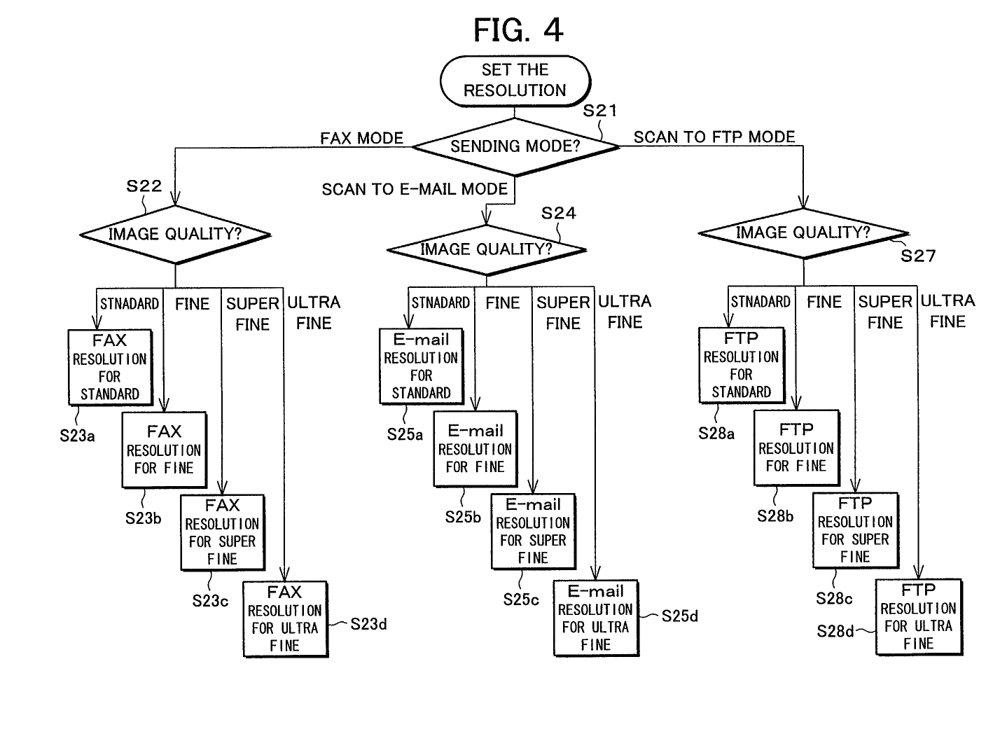

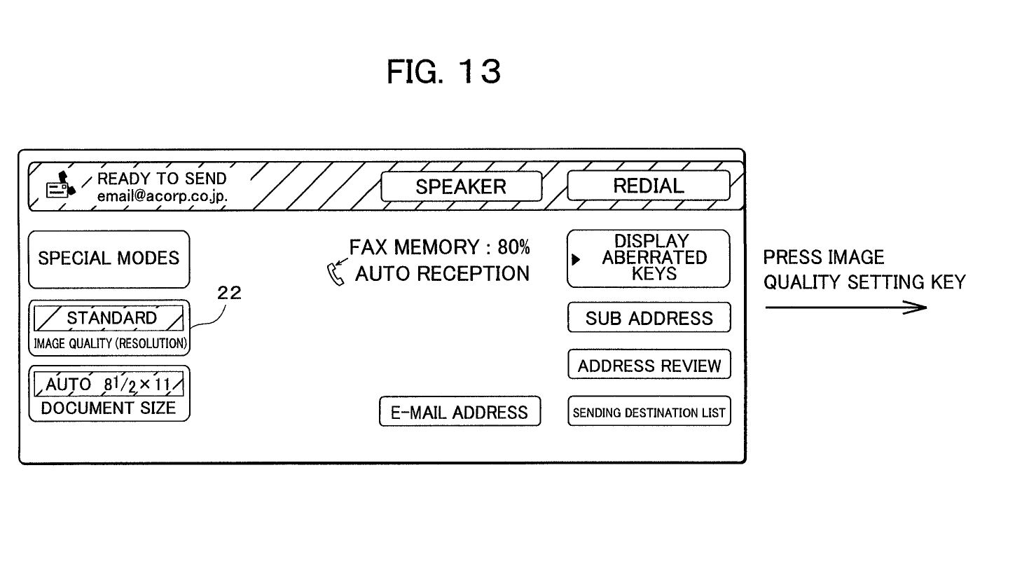

The following will explain a method of setting a resolution when sending image data to a sending destination with reference to FIG. 4, FIG. 5, FIGS. 13 through 16.

As shown in FIG. 3, the image sending device 10 first sets the sending mode and the sending destination (S14), then scans the document (S15), and stores the image data (S16), and thereafter sets the resolution of the sending image data (S17).

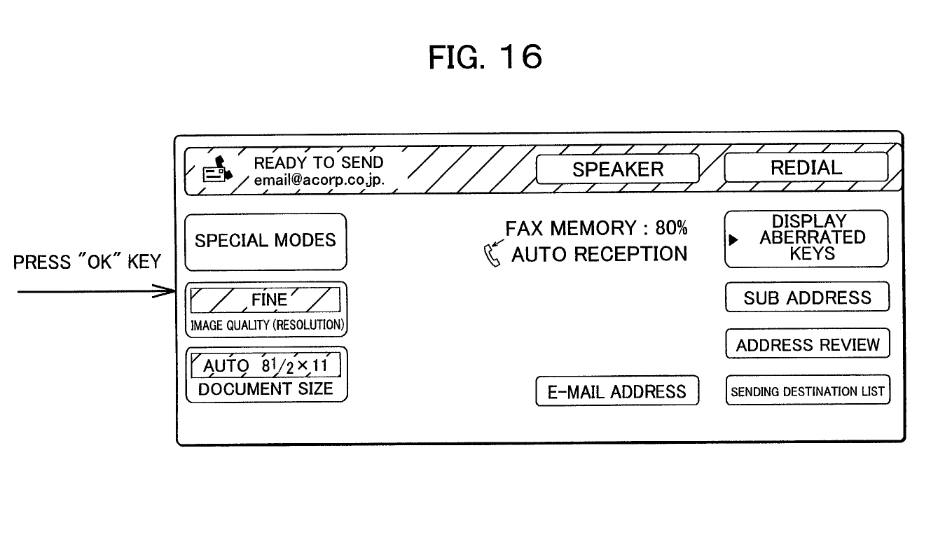

The image setting section 32 of the control section 12 displays the screen of FIG. 14 when a user press the image quality setting key 22 in the screen of the control panel 11 shown in FIG. 13. In the screen, image quality keys 27a through 27d are shown, enabling user to make a selection from the four types of image quality for the sending image data: “standard”, “fine”, “super fine” and “ultra fine”. The user selects the image quality of the sending image data by selecting one of the image quality keys 27a through 27d and pressing the “OK” key as the confirmation (FIG. 16). Note that, no matter which sending mode is selected, the image quality is set in the screen of FIG. 14.

Then, the resolution setting section 33 extracts the resolution of the sending image data referring to the resolution setting table 34 (FIG. 5) based on the sending mode set by the sending destination/sending mode setting section 31 (S21) and the image quality set by the image quality setting section 32 (S22, S24, S27, FIG. 14) (S23a through S23d, S25a through S25d, S28a through S28d).

Here, as shown in FIG. 4 and FIG. 5, even when image qualities are the same, the resolutions differ depending on the type of the sending mode. For example, at the image quality of “standard”, the resolution is 203.2 dpi×97.8 dpi in the fax mode, and 200.0 dpi×100.0 dpi in the Scan to E-mail mode. This is because the upper limits of resolutions or the maximum data volume of sendable image data vary depending on the type of sending mode.

Note that, three sending modes are available for the image sending device 10 and resolutions corresponding to the default sending modes are normally selected in the resolution setting table 34 (FIG. 5). When other sending modes are specified, the resolution setting table 34 selects resolutions of these sending modes. Subsequently, when the image quality is specified, the corresponding resolution is extracted from the resolutions of the sending modes and is used for the conversion of image data.

As described, the resolutions cannot be matched even when the same image quality “fine” is set for different sending modes such as the fax mode, scan to E-mail mode and Scan to FTP mode, since the upper limits of resolutions or the maximum data volume of sendable image data vary depending on the type of sending mode. Thus, the user has to set the resolution for each sending mode though it is difficult to correctly set the resolution for those users who are not knowledgeable about resolution.

This being the case, the image sending device 10 sets image quality levels (coarse, standard, fine, etc.) which are common to all sending modes in advance to create the resolution setting table 34 (FIG. 5) which sets the resolutions corresponding to all possible combinations of the sending modes and image quality levels. Then, by extracting a resolution from the resolution setting table based on the sending mode and the image quality which are specified by a user, it becomes possible to convert image data with the optimum resolution for the selected image quality through the selected sending mode.

Thus, the user is not required to set the resolution value according to the selected sending mode, and it is possible to correctly set the resolution even for a user who is not knowledgeable about resolution.

Note that, in the present embodiment, a telephone line or the Internet are mainly assumed as the sending route such as a communication line. However, the sending route is not limited to these examples above but other intranet, extranet, CON, COM, LAN (Local Area network), ISDN (Integrated Services Digital Network), VAN (Value Added Network), CATV network (Cable Television), VPN (Virtual Private Network), a telephone line network, a mobile network, a satellite network and the like can also be used. Other applicable examples include wire communications, radio communications, and optical communications.

Further, in the present embodiment, though the resolution of an image is selected for each type of sending mode, it is also possible to suitably select the resolution of an image according to the sending route as exemplified above.

Further, the sending mode is not just limited to the foregoing three types: the fax mode, scan to E-mail mode, and scan to FTP mode. Further, the indices of image quality may be of any kind as long as they are common to a plurality of different sending modes, convertible to resolutions using a table, and easy to understand for a user who is not knowledgeable about the resolution. Therefore, the image quality is not just limited to the foregoing four levels: “standard”, “fine”, “super fine” and “ultra fine”.

Further, in the present embodiment, the image processing section 36 converts image data based on the resolution set by the resolution setting section 33. However, the image data based on the resolution may be set by the scanner 13 as well. In this case, the conversion of image data in the image processing section 36 can be omitted.

Further, the present embodiment described the case where the resolution differs depending on the type of sending mode. However, depending on the sending mode, there are cases where the sendable image size or the sendable number of colors may be restricted.

In order to make the present invention applicable to such a case, there are created indices of processing contents which are common to all sending modes, and a processing contents setting table which stores processing contents respectively corresponding to the sending modes and indices, so that the image processing section can process the image data based on the processing contents.

This allows a user who is not knowledgeable about processing contents to correctly set the processing contents by only selecting the sending mode and index, thereby suitably processing the image data for the sending mode.

The present embodiment is not to limit the scope of the present invention, and may be varied in many ways within the scope of the present invention. For example, the following arrangement is also possible.

The image sending device may have an arrangement including sending mode setting means which has plural sending modes for setting a mode for sending image data, image quality setting means having plural selecting keys for selecting a level of image quality (resolution), for setting an image quality (resolution) of the image data with the sending mode set by the sending mode setting means, control means for performing processing control of the image data based on the condition set by the sending mode setting means and the image quality setting means, wherein the control means sets different values for the resolutions of the plurality of sending modes respectively corresponding to the plurality of selecting keys.

This allows a user who is not knowledgeable about resolution to easily set the resolution by selecting a sending mode and a selecting key so that a suitable value is set for the resolution selected for each sending mode.

Further, the image sending device may have an arrangement such that the plural sending modes include a fax sending mode which uses abbreviated keys or number keys for inputting.

This makes it possible to set the fax sending mode for the registered destinations using the abbreviated keys which require less key stroke for entry. Also, the sending mode setting means sets the fax sending mode by the entry of the fax number using the number keys for the unregistered destinations. Thus, it is not necessary to independently set the sending mode.

Further, the image sending device may have an arrangement such that the plural sending modes include an E-mail sending mode or an FTP sending mode which uses abbreviated keys or E-mail keys for inputting.

This makes it possible to set the E-mail sending mode or FTP sending mode for the registered destinations using the abbreviated keys which require less key stroke for entry. Also, the sending mode setting means sets the E-mail sending mode or FTP sending mode by entry of an E-mail address using E-mail keys for the unregistered destinations. Thus, it is not necessary to independently set the sending mode.

Further, the image sending device may have an arrangement such that the resolution of the FTP sending mode is set based on a ratio of the resolution for scanning the document image to the resolution of the E-mail sending mode.

This makes it possible to set a suitable resolution among the various resolutions of the FTP sending mode by calculating it from the resolution ratio, using the resolution of the E-mail sending mode as a reference value.

Further, the image sending device may have an arrangement such that the resolution setting means includes storage means which stores a resolution setting table storing resolutions respectively corresponding to the plurality of selecting keys of the sending modes.

This makes it possible to select a suitable resolution only by matching the iuputted sending mode and the selected selection key to the table.

As described, the image sending method according to the present invention selects and sets the sending mode for sending image data from plural types of sending modes, then sets an image quality for the sending image data, and sets a resolution corresponding to the selected image quality selected from a range of applicable resolutions for the selected sending mode, and also, sends the image data of the selected resolution by the selected sending mode.

This makes it possible to select and set a resolution suitable for the sending mode by specifying the level (e.g., coarse, standard, fine) of the image quality of the sending image data. Therefore, it becomes possible to simplify the resolution setting when selecting one of plural sending modes of different resolutions and when sending the image data through the selected sending mode. Accordingly, it becomes easier for a user who is not knowledgeable about resolution to select and set a suitable value for each sending mode from the plural resolutions.

Further, as described, the image sending method according to the present invention in the foregoing method selects and sets the resolution corresponding to the selected image quality by referring to a resolution setting table which indicates correspondence between a single or plural indices of the image quality common to the plural types of sending modes and the a applicable ranges of resolution of each sending mode.

This makes it possible to easily select the optimum resolution for the selected sending mode and the selected image quality by referring to the resolution setting table. Besides, it is easy to grasp a state of the sending data since the index of the image quality is common to the plural sending modes. Consequently, it becomes even more easier for a user who is not knowledgeable about resolution to select and set a suitable value for each sending mode from the plural resolutions.

Note that, in the case where there are plural indices, in order to ensure the foregoing effect, it is preferable in the image sending method that displays the plural indices, and sets the image quality for the image data to be sent according to the one of the indices which is selected and entered by the user.

Further, as described, the image sending method according to the present invention in the foregoing method selects and sets the sending mode for sending image data from the plural types of sending modes based on sending destination information inputted or selected by a user.

This has the effect of allowing the user to omit the task of specifying the sending mode, because the sending mode is set when the user inputs or selects the sending destination information such as a fax number, an E-mail address or the like.

Note that, the image data may be sent after processing it into a form suitable for the selected sending mode based on the selected resolution after selecting the resolution. Further, the image data may be sent by creating it from a read-out image based on the selected resolution after selecting the resolution.

Further, an image sending device according to the present invention includes sending mode setting means for selecting and setting a sending mode for sending image data from plural types of sending modes, image quality setting means for setting the image quality for the image data to be sent, and resolution setting means for selecting and setting a resolution corresponding to the image quality set by the image quality setting means from a range of applicable resolutions for the sending mode set by the sending mode setting means.

Therefore, specifying the level of image quality of the sending image data allows the resolution setting means to set the resolution suitable for the sending mode, thereby simplifying the resolution setting of plural sending modes of different resolutions. This makes it easier for a user who is not knowledgeable about resolution to select and set a suitable resolution for each sending mode from the plural resolutions.

Further, as described, in the image sending device according to the present invention in the foregoing structure, the resolution setting means refers to a resolution setting table which stores a range of applicable resolutions of each sending mode, with a corresponding index which is a single or plural indices of the image quality common to the plural types of sending modes.

This makes it possible to easily select the optimum resolution by referring to the resolution setting table based on the sending mode and image quality. Besides, it is easy to grasp a state of the sending data, because the index of the image quality is common to the plural sending modes. This makes it easier for a user who is not knowledgeable about resolution to select and set a suitable value for each sending mode from the plural resolutions.

Note that, in the case where there are plural indices, in order to ensure the foregoing effect, it is preferable that the image sending device according to the present invention is further includes display means for displaying the plural indices, and input means for enabling a user to input one of the indices. And it is preferable that the image quality setting means sets the image quality according to index which is inputted by the input means.

As described, the image sending device according to the present invention in the foregoing structure further includes input means for enabling a user to input or select sending destination information. And the sending mode setting means selects and sets the sending mode based on the sending destination information inputted or selected through the input means.

This has the effect of allowing the user to omit the task of specifying the sending mode, because the sending mode is set when the user inputs or selects the sending destination information such a fax number and an E-mail address or the like.

Note that, in order to send the image data of the selected resolution, it is preferable that the image sending device further includes image data processing means for processing the image data based on the selected resolution into a form suitable for the sending mode set by the sending mode setting means. Note that, instead of the image data processing means, there may be provided image data scanning means for creating image data by scanning image data based on the resolution selected by the resolution setting means, may be equipped.

Further, as described, an image sending device according to the present invention includes a sending route setting section for selecting and setting a sending route from plural image sending routes, an image quality setting section for setting an image quality of a sending image, a processing contents setting section for setting processing contents which corresponds to the image sending route set by the sending route setting section and the image quality set by the image quality setting section, and an image processing section for processing the image to create the sending image based on the processing contents set by the processing contents setting section, and an image sending section for sending the image via the selected image sending route.

This makes it easier to set the processing contents when selecting one of plural sending routes having different image processing contents, and when sending an image through the selected sending route, thereby making it easier for a user who is not knowledgeable about processing contents to select and set suitable processing contents for each sending route from plural processing contents.

Note that, it is preferable that the image quality set by the image quality setting means is commonly used for the plural image sending routes.

This allows a user to more easily grasp a state of the sending image data since the image quality is set without depending on the image sending route but by selecting the image quality from, for example, coarse, standard, fine, etc.

Further, it is preferable that the image sending device further includes a storage section for a processing contents setting table which stores processing contents corresponding to each of the plural image sending routes and the image quality.

In this way, it becomes easier to select the optimum processing contents by referring to the processing contents setting table based on the selected image sending route and image quality. This makes it easier for a user who is not knowledgeable about processing contents to select and set suitable processing contents for each image sending route from the plural processing contents.

Note that, in the case where there are plural image qualities, in order to ensure the foregoing effect, it is preferable that the image sending device includes a display section for displaying the image quality which exists as plural image qualities, and an input section for enabling a user to input one of the plural image qualities, and the image quality setting section selects and sets the image quality inputted through the input section.

Further, it is preferable that the image sending device includes a sending destination input section for enabling a user to select or input sending destination information, and the sending route setting section selects and sets the sending route selected from the plural image sending routes based on the sending destination information inputted or selected by the sending destination input section.

In this case, there is an advantage of allowing the user to omit the task of specifying the sending mode, because the sending mode is set when the user inputs or selects the sending destination information such as a fax number, an E-mail address or the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An image sending method comprising the steps of:
selecting and setting a sending mode for sending image data from plural types of sending modes;
setting an image quality for the image data to be sent;
selecting and setting a resolution corresponding to the selected image quality from a range of applicable resolutions for the selected sending mode; and
sending the image data of the selected resolution by the selected sending mode.

2. The image sending method set forth in claim 1, wherein:
the resolution corresponding to the selected image quality is selected and set by referring to a resolution setting table which indicates correspondence between (i) an index which is a single or plural indices of the image quality common to the plural types of sending modes and (ii) a range of applicable resolutions of each sending mode.

3. The image sending method set forth in claim 2, wherein:
the image quality of the image data to be sent is set according to the index which is selected by a user from a plurality of displayed indices.

4. The image sending method set forth in claim 1, wherein:
the sending mode for sending image data is selected and set from plural types of sending modes based on sending destination information which is inputted or selected by a user.

5. The image sending method set forth in claim 1, wherein:
the image data is processed to match the selected resolution.

6. The image sending method set forth in claim 1, wherein:
the image data is created by reading an image, so as to match the selected resolution.

7. An image sending device comprising:
sending mode setting means for selecting and setting a sending mode for sending image data from plural types of sending modes;
image quality setting means for setting an image quality for the image data to be sent; and
resolution setting means for selecting and setting a resolution corresponding to the image quality set by said image quality setting means, from a range of applicable resolutions for the sending mode set by said sending mode setting means.

8. The image sending device set forth in claim 7 wherein:
said resolution setting means refers to a resolution setting table which stores a range of applicable resolutions of each sending mode, with a corresponding index which is a single or plural indices of the image quality common to the plural types of sending modes.

9. The image sending device set forth in claim 8, further comprising:
display means for displaying the plural indices; and
input means for enabling a user to input one of the plural indices,
wherein:
said image quality setting means sets the image quality according to the index which is inputted by the input means.

10. The image sending device set forth in claim 7, further comprising:
input means for enabling a user to input or select sending destination information,
wherein:
said sending mode setting means selects and sets the sending mode based on the sending destination information inputted or selected through the input means.

11. The image sending device set forth in claim 7, further comprising:
image data processing means for processing the image data based on the resolution set by said resolution setting means, into a form suitable for the sending mode set by said sending mode setting means.

12. The image sending device set forth in claim 7, further comprising:
image reading means for reading an image based on the resolution set by the resolution setting means, so as to create image data.

13. An image sending device comprising:
a sending route setting section for selecting and setting a sending route from plural image sending routes;
an image quality setting section for setting an image quality of a sending image;
a processing contents setting section for setting processing contents which corresponds to the image sending route set by said sending route setting section and the image quality set by said image quality setting section;
an image processing section for processing the image to create the sending image based on the processing contents set by said processing contents setting section; and
an image sending section for sending the sending image via the image sending route set by said sending route setting section.

14. The image sending device set forth in claim 13, wherein:
the image quality set by said image quality setting section is commonly used for the plural image sending routes.

15. The image sending device set forth in claim 14, further comprising:
a storage section for storing a processing contents setting table which stores processing contents corresponding to each of the plural image sending routes and the image quality.

16. The image sending device set forth in claim 15, further comprising:
a display section for displaying the image quality which exists as plural image qualities; and
an input section for enabling a user to input one of the plural image qualities,
wherein:
said image quality setting section selects and sets the image quality inputted through the input section.

17. The image sending device set forth in claim 13, further comprising:
a sending destination input section for enabling a user to input or select sending destination information,
wherein:
said sending route setting section selects and sets the sending route from the plural image sending routes based on the sending destination information inputted or selected through the sending destination input section.
